(19) United States
(12) Patent Application Publication
(10) Pub. No.: US 2021/0400276 A1
(43) Pub. Date: Dec. 23, 2021

(54) QUANTIZATION FOR VIDEO ENCODING AND DECODING

(71) Applicant: InterDigital VC Holdings, Inc., Wilmington, DE (US)

(72) Inventors: YA CHEN, Rennes (FR); Fabrice Le Leannec, Mouaze (FR); Karam Naser, Mouaze (FR)

(21) Appl. No.: 17/292,728

(22) PCT Filed: Nov. 19, 2019
(86) PCT No.: PCT/US2019/062114

§ 371 Date: May 11, 2021

(30) Foreign Application Priority Data
Nov. 22, 2018 (EP) 18306550.7
Aug. 21, 2019 (EP) 19306024.1

(51) Int. Cl. H04N 19/124; H04N 19/103; H04N 19/18; H04N 19/176; H04N 19/186

(52) U.S. Cl. CPC H04N 19/124; H04N 19/103; H04N 19/186; H04N 19/176; H04N 19/18

(57) ABSTRACT

At least a method and an apparatus are presented for efficiently encoding or decoding video. For example, a quantization mode selection condition is obtained. A first quantization mode is selected for processing a first portion of a set of transform coefficients based on the quantization mode selection condition. A second quantization mode is selected for processing a second portion of the set of transform coefficients based on the quantization mode selection condition. The video is encoded or decoded based on the processed first and second portions of the set of transform coefficients.

### TECHNICAL FIELD

The present embodiments generally relate to a method and an apparatus for video encoding or decoding, and more particularly, to a method and an apparatus for efficiently encoding and decoding of video in which a quantization mode for processing respectively a first portion and a second portion of a set of transform coefficients is selected based on a quantization mode selection condition.

### BACKGROUND

To achieve high compression efficiency, image and video coding schemes usually employ predictive and transform coding to leverage spatial and temporal redundancy in the video content. Generally, intra or inter prediction is used to exploit the intra or inter frame correlation, then the differences between the original blocks and the predicted blocks, often denoted as prediction errors or prediction residuals, are transformed, quantized, and entropy coded. To reconstruct the video, the compressed data is decoded by inverse processes corresponding to the prediction, transform, quantization, and entropy coding.

Recent additions to video compression technology include various versions of the reference software and/or documentations Joint Exploration Model (JEM) being developed by the Joint Video Exploration Team (JVET) as part of a new video coding standard known as Versatile Video Coding (VVC). The aim is to make further improvements to the existing HEVC (High Efficiency Video Coding) standard.

### SUMMARY

According to a general aspect of at least one embodiment in accordance with the present disclosure, a method for video encoding is presented, comprising obtaining a quantization mode selection condition; selecting a first quantization mode for processing a first portion of a set of transform coefficients based on the quantization mode selection condition; selecting a second quantization mode for processing a second portion of the set of transform coefficients based on the quantization mode selection condition; and encoding the video based on the processed first and second portions of the set of transform coefficients.

According to a general aspect of at least one embodiment in accordance with the present disclosure, an apparatus for video encoding is presented, comprising one or more processors configured to obtain a quantization mode selection condition; select a first quantization mode for processing a first portion of a set of transform coefficients based on the quantization mode selection condition; select a second quantization mode for processing a second portion of the set of transform coefficients based on the quantization mode selection condition; and encode the video based on the processed first and second portions of the set of transform coefficients.

According to a general aspect of at least one embodiment, an apparatus for video encoding is presented comprising means for obtaining a quantization mode selection condition; means for selecting a first quantization mode for processing a first portion of a set of transform coefficients based on the quantization mode selection condition; means for selecting a second quantization mode for processing a second portion of the set of transform coefficients based on the quantization mode selection condition; and means for encoding the video based on the processed first and second portions of the set of transform coefficients.

According to a general aspect of at least one embodiment, a method for video decoding is presented comprising obtaining a quantization mode selection condition; selecting a first quantization mode for processing a first portion of a set of transform coefficients based on the quantization mode selection condition; selecting a second quantization mode for processing a second portion of the set of transform coefficients based on the quantization mode selection condition; and decoding the video based on the processed first and second portions of the set of transform coefficients.

According to a general aspect of at least one embodiment, apparatus for video decoding is presented, comprising one or more processors configured to obtain a quantization mode selection condition; select a first quantization mode for processing a first portion of a set of transform coefficients based on the quantization mode selection condition; select a second quantization mode for processing a second portion of the set of transform coefficients based on the quantization mode selection condition; and decode the video based on the processed first and second portions of the set of transform coefficients.

According to a general aspect of at least one embodiment, an apparatus for video decoding is presented comprising means for obtaining a quantization mode selection condition; means for selecting a first quantization mode for processing a first portion of a set of transform coefficients based on the quantization mode selection condition; means for selecting a second quantization mode for processing a second portion of the set of transform coefficients based on the quantization mode selection condition; and means for decoding the video based on the processed first and second portions of the set of transform coefficients.

In at least one embodiment, one or more syntax elements is provided an indication of a quantization mode selection condition enabling selecting a first quantization mode based on the condition for processing a first portion of a set of transform coefficients, selecting a second quantization mode based on the condition for processing a second portion of the set of transform coefficients, and encoding and/or decoding video information based on the processing of the first and second portions.

According to another general aspect of at least one embodiment, a bitstream comprising video is presented, wherein the bitstream is formed by obtaining a quantization mode selection condition; selecting a first quantization mode for processing a first portion of a set of transform coefficients based on the quantization mode selection condition; selecting a second quantization mode for processing a second portion of the set of transform coefficients based on the quantization mode selection condition; and encoding the video into the bitstream based on the processed first and second portions of the set of transform coefficients.

One or more of the present embodiments also provide a computer readable storage medium having stored thereon instructions for encoding or decoding video data in accordance with one or more aspects and/or embodiments described herein.

One or more of the present embodiments can also involve a non-transitory computer readable medium storing executable program instructions to cause a computer executing the instructions to perform a method according to any embodiment in accordance with the present disclosure.

The present embodiments also provide a computer readable storage medium having stored thereon a bitstream generated in accordance with one or more aspects and/or embodiments described herein.

The present embodiments also provide a method and apparatus for transmitting the bitstream generated in accordance with one or more aspects and/or embodiments described herein.

### BRIEF DESCRIPTION OF THE DRAWINGS

The present disclosure may be better understood by consideration of the detailed description below in conjunction with the accompanying figures, in which:

FIG. 1 illustrates a block diagram of an example of an embodiment of a video encoder;

FIG. 2 illustrates a block diagram of an example of an embodiment of a video decoder;

FIG. 3 illustrates Coding Tree Unit (CTU) and Coding Tree (CT) concepts to represent a compressed HEVC picture;

FIG. 4 illustrates division of a Coding Tree Unit (CTU) into Coding Units (CU), Prediction Units (PU) and Transform Units (TU);

FIG. 5 illustrates an example of two scalar quantizers used in accordance with one or more aspects described herein;

FIG. 6 illustrates an example of a state transition and quantizer selection in accordance with one or more aspects described herein;

FIG. 7 illustrates an example of an encoding method in accordance with one or more aspects described herein;

FIG. 8 illustrates an example of a decoding method in accordance with one or more aspects described herein;

FIG. 9 illustrates an example of control of quantization in accordance with one or more aspects described herein; and

FIG. 10 illustrates a block diagram of an example of a system suitable for implementing one or more of various aspects, embodiments and features in accordance with the present disclosure.

It should be understood that the drawings are for purposes of illustrating examples of various aspects and embodiments and are not necessarily the only possible configurations. Throughout the various figures, like reference designators refer to the same or similar features.

### DETAILED DESCRIPTION

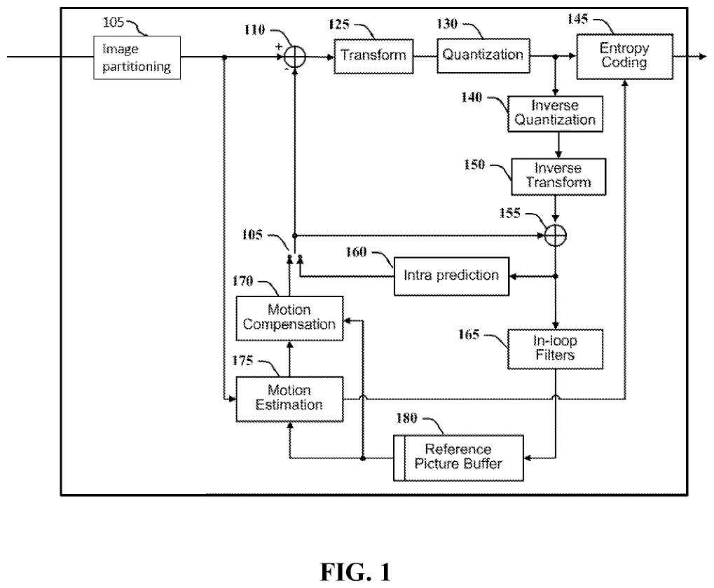

Turning now to the figures, FIG. 1 illustrates an example of a video encoder 100, such as a High Efficiency Video Coding (HEVC) encoder. FIG. 1 may also illustrate an encoder in which improvements are made to the HEVC standard or an encoder employing technologies similar to HEVC, such as a JEM (Joint Exploration Model) encoder under development by JVET (Joint Video Exploration Team) as part of development of a new video coding standard known as Versatile Video Coding (VVC).

In the present application, the terms “reconstructed” and “decoded” may be used interchangeably, the terms “encoded” or “coded” may be used interchangeably, and the terms “image,” “picture” and “frame” may be used interchangeably. Usually, but not necessarily, the term “reconstructed” is used at the encoder side while “decoded” is used at the decoder side.

Before being encoded, the video sequence may go through pre-encoding processing (101), for example, applying a color transform to the input color picture (e.g., conversion from RGB 4:4:4 to YCbCr 4:2:0), or performing a remapping of the input picture components in order to get a signal distribution more resilient to compression (for instance using a histogram equalization of one of the color components). Metadata can be associated with the pre-processing, and attached to the bitstream.

In HEVC, to encode a video sequence with one or more pictures, a picture is partitioned (102) into one or more slices where each slice can include one or more slice segments. A slice segment is organized into coding units, prediction units, and transform units. The HEVC specification distinguishes between “blocks” and “units,” where a “block” addresses a specific area in a sample array (e.g., luma, Y), and the “unit” includes the collocated blocks of all encoded color components (Y, Cb, Cr, or monochrome), syntax elements, and prediction data that are associated with the blocks (e.g., motion vectors).

For coding in HEVC, a picture is partitioned into coding tree blocks (CTB) of square shape with a configurable size, and a consecutive set of coding tree blocks is grouped into a slice. A Coding Tree Unit (CTU) contains the CTBs of the encoded color components. A CTB is the root of a quadtree partitioning into Coding Blocks (CB), and a Coding Block may be partitioned into one or more Prediction Blocks (PB) and forms the root of a quadtree partitioning into Transform Blocks (TBs). Corresponding to the Coding Block, Prediction Block, and Transform Block, a Coding Unit (CU) includes the Prediction Units (PUs) and the tree-structured set of Transform Units (TUs), a PU includes the prediction information for all color components, and a TU includes residual coding syntax structure for each color component. The size of a CB, PB, and TB of the luma component applies to the corresponding CU, PU, and TU.

In JEM, the QTBT (Quadtree plus Binary Tree) structure removes the concept of multiple partition types in HEVC, i.e., removes the separation of CU, PU and TU concepts. A Coding Tree Unit (CTU) is first partitioned by a quadtree structure. The quadtree leaf nodes are further partitioned by a binary tree structure. The binary tree leaf node is named as Coding Units (CUs), which is used for prediction and transform without further partitioning. Thus, the CU, PU and TU have the same block size in the new coding QTBT block structure. In JEM, a CU consists of Coding Blocks (CBs) of different color components.

In the present application, the term “block” can be used to refer, for example, to any of CTU, CU, PU, TU, CB, PB, and TB. In addition, the “block” can also be used to refer to a macroblock and a partition as specified in H.264/AVC or other video coding standards, and more generally to refer to an array of data of various sizes.

In the exemplary encoder 100, a picture is encoded by the encoder elements as described below. The picture to be encoded is processed in units of CUs. Each CU is encoded using either an intra or inter mode. When a CU is encoded in an intra mode, it performs intra prediction (160). In an inter mode, motion estimation (175) and compensation (170) are performed. The encoder decides (105) which one of the intra mode or inter mode to use for encoding the CU, and indicates the intra/inter decision by a prediction mode flag. Prediction residuals are calculated by subtracting (110) the predicted block from the original image block.

CUs in intra mode are predicted from reconstructed neighboring samples within the same slice. A set of 35 intra prediction modes is available in HEVC, including a DC, a planar, and 33 angular prediction modes. The intra prediction reference is reconstructed from the row and column adjacent to the current block. The reference extends over two times the block size in the horizontal and vertical directions using available samples from previously reconstructed blocks. When an angular prediction mode is used for intra prediction, reference samples can be copied along the direction indicated by the angular prediction mode.

The applicable luma intra prediction mode for the current block can be coded using two different options in HEVC. If the applicable mode is included in a constructed list of three most probable modes (MPM), the mode is signaled by an index in the MPM list. Otherwise, the mode is signaled by a fixed-length binarization of the mode index. The three most probable modes are derived from the intra prediction modes of the top and left neighboring blocks.

Current proposals in JEM increase the number of the intra prediction modes compared with HEVC. JEM 3.0 uses 65 directional intra prediction modes in addition to the planar mode 0 and the DC mode 1. The directional intra prediction modes are numbered from 2 to 66 in the increasing order, in the same fashion as done in HEVC from 2 to 34. The 65 directional prediction modes include the 33 directional prediction modes specified in HEVC plus 32 additional directional prediction modes that correspond to angles in-between two original angles. In other words, the prediction direction in JEM has twice the angle resolution of HEVC. The higher number of prediction modes has been proposed to exploit the possibility of finer angular structures with proposed larger block sizes.

For an inter CU in HEVC, the corresponding coding block is further partitioned into one or more prediction blocks. Inter prediction is performed on the PB level, and the corresponding PU contains the information about how inter prediction is performed. The motion information (e.g., motion vector and reference picture index) can be signaled in two methods, namely, “merge mode” and “advanced motion vector prediction (AMVP)”.

In the merge mode, a video encoder or decoder assembles a candidate list based on already coded blocks, and the video encoder signals an index for one of the candidates in the candidate list. At the decoder side, the motion vector (MV) and the reference picture index are reconstructed based on the signaled candidate.

In AMVP, a video encoder or decoder assembles candidate lists based on motion vectors determined from already coded blocks. The video encoder then signals an index in the candidate list to identify a motion vector predictor (MVP) and signals a motion vector difference (MVD). At the decoder side, the motion vector (MV) is reconstructed as MVP+MVD. The applicable reference picture index is also explicitly coded in the PU syntax for AMVP.

The prediction residuals are then transformed (125) and quantized (130). The transforms are generally based on separable transforms. For instance, a DCT transform is first applied in the horizontal direction, then in the vertical direction. For HEVC, transform block sizes of 4×4, 8×8, 16×16, and 32×32 are supported. The elements of the core transform matrices were derived by approximating scaled discrete cosine transform (DCT) basis functions. The HEVC transforms are designed under considerations such as limiting the dynamic range for transform computation and maximizing the precision and closeness to orthogonality when the matrix entries are specified as integer values. For simplicity, only one integer matrix for the length of 32 points is specified, and subsampled versions are used for other sizes. For the transform block size of 4×4, an alternative integer transform derived from a discrete sine transform (DST) is applied to the luma residual blocks for intra prediction modes.

In JEM, the transforms used in both directions may differ (e.g., DCT in one direction, DST in the other one), which leads to a wide variety of 2D transforms, while in previous codecs, the variety of 2D transforms for a given block size is usually limited.

The quantized transform coefficients, as well as motion vectors and other syntax elements, are entropy coded (145) to output a bitstream. The encoder may also skip the transform and apply quantization directly to the non-transformed residual signal on a 4×4 TU basis. The encoder may also bypass both transform and quantization, i.e., the residual is coded directly without the application of the transform or quantization process. In direct PCM coding, no prediction is applied and the coding unit samples are directly coded into the bitstream.

The encoder decodes an encoded block to provide a reference for further predictions. The quantized transform coefficients are de-quantized (140) and inverse transformed (150) to decode prediction residuals. Combining (155) the decoded prediction residuals and the predicted block, an image block is reconstructed. In-loop filters (165) are applied to the reconstructed picture, for example, to perform deblocking/SAO (Sample Adaptive Offset) filtering to reduce encoding artifacts. The filtered image is stored at a reference picture buffer (180).

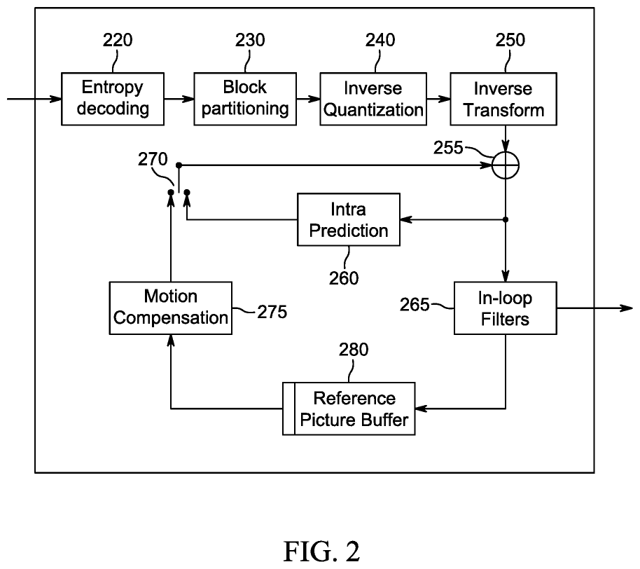

FIG. 2 illustrates a block diagram of an exemplary video decoder 200, such as an HEVC decoder. In the exemplary decoder 200, a bitstream is decoded by the decoder elements as described below. Video decoder 200 generally performs a decoding pass reciprocal to the encoding pass as described in FIG. 1, which performs video decoding as part of encoding video data. FIG. 2 may also illustrate a decoder in which improvements are made to the HEVC standard or a decoder employing technologies similar to HEVC, such as a JEM decoder.

In particular, the input of the decoder includes a video bitstream, which may be generated by video encoder 100. The bitstream is first entropy decoded (230) to obtain transform coefficients, motion vectors, picture partitioning information, and other coded information. For HEVC, the picture partitioning information indicates the size of the CTUs, and a manner a CTU is split into CUs, and possibly into PUs when applicable. The decoder may therefore divide (235) the picture into CTUs, and each CTU into CUs, according to the decoded picture partitioning information. For JEM, the decoder may divide the picture based on the partitioning information indicating the QTBT structure. The transform coefficients are de-quantized (240) and inverse transformed (250) to decode the prediction residuals.

Combining (255) the decoded prediction residuals and the predicted block, an image block is reconstructed. The predicted block may be obtained (270) from intra prediction (260) or motion-compensated prediction (i.e., inter prediction) (275). As described above, AMVP and merge mode techniques may be used to derive motion vectors for motion compensation, which may use interpolation filters to calculate interpolated values for sub-integer samples of a reference block. In-loop filters (265) are applied to the reconstructed image. The filtered image is stored at a reference picture buffer (280).

The decoded picture can further go through post-decoding processing (285), for example, an inverse color transform (e.g. conversion from YCbCr 4:2:0 to RGB 4:4:4) or an inverse remapping performing the inverse of the remapping process performed in the pre-encoding processing (101). The post-decoding processing may use metadata derived in the pre-encoding processing and signaled in the bitstream.

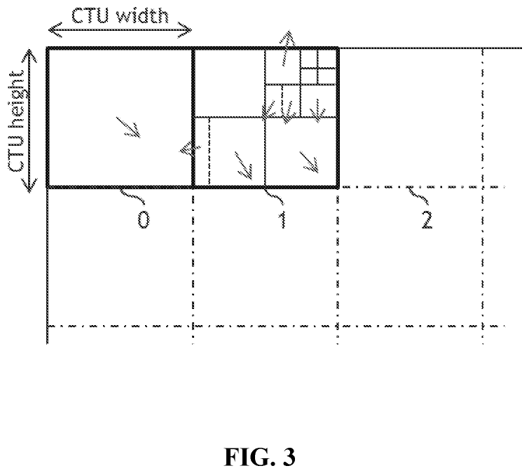

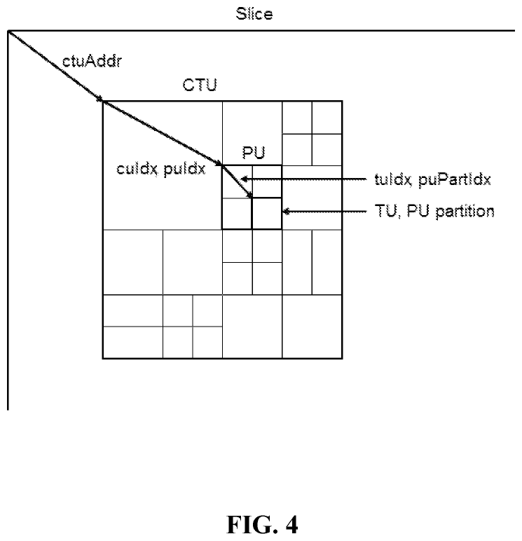

In the HEVC video compression standard, a picture is divided into so-called Coding Tree Units (CTU), which size is typically 64×64, 128×128, or 256×256 pixels. Each CTU is represented by a Coding Tree in the compressed domain. This is a quad-tree division of the CTU, where each leaf is called a Coding Unit (CU), as illustrated in FIG. 3. Each CU is then given some Intra or Inter prediction parameters (Prediction Info). To do so, each CU is spatially partitioned, or split, into one or more Prediction Units (PUs), each PU being assigned some prediction information. The Intra or Inter coding mode is assigned on the CU level as illustrated in FIG. 4.

Intra or inter prediction is used to exploit the intra or inter frame correlation, then the differences between the original block and the predicted block, often denoted as prediction errors or prediction residuals, are transformed, quantized, and entropy coded. To reconstruct the video, the compressed data are decoded by inverse processes corresponding to the entropy coding, quantization, transform, and prediction.

A form of quantization referred to as dependent scalar quantization involves using two scalar quantizers with different reconstruction levels for quantization. In comparison to conventional independent scalar quantization, e.g., as used in HEVC, dependent scalar quantization involves a set of admissible reconstruction values for a transform coefficient that depends on the values of the transform coefficient levels that precede the current transform coefficient level in reconstruction order.

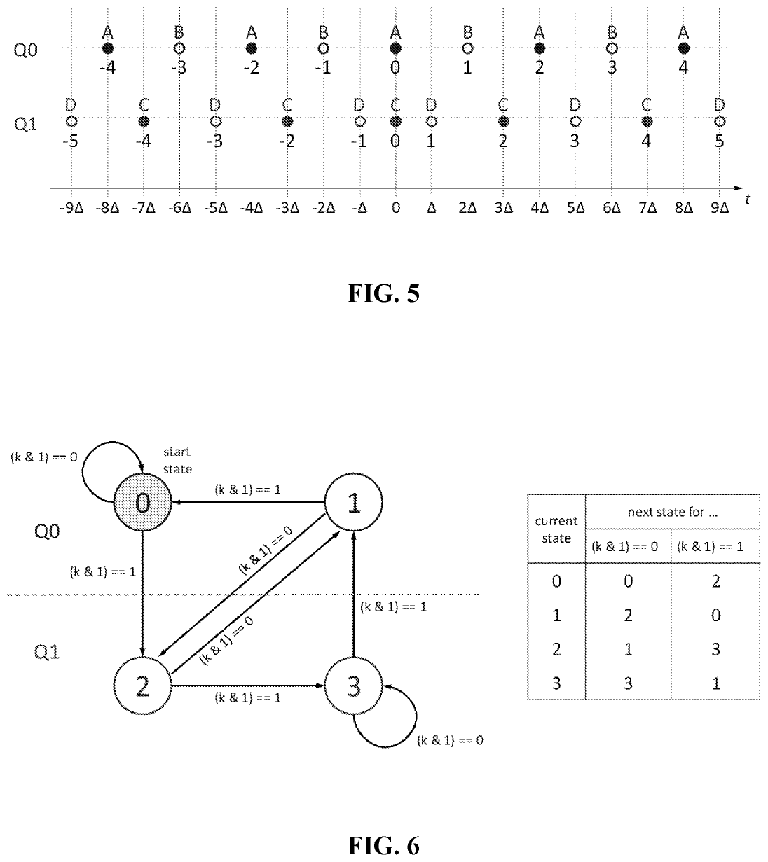

Dependent scalar quantization can be realized by: (a) defining two scalar quantizers with different reconstruction levels, and (b) defining a process for switching between the two scalar quantizers. For example, FIG. 5 illustrates two scalar quantizers, denoted by Q0 and Q1, that can be used in the dependent scalar quantization approach. The location of the available reconstruction levels is uniquely specified by a quantization step size Δ. If we neglect the fact that the actual reconstruction of transform coefficients uses integer arithmetic, the two scalar quantizers Q0 and Q1 are characterized as follows:
Q0: The reconstruction levels of the first quantizer Q0 are given by the even integer multiples of the quantization step size Δ. When this quantizer is used, a reconstructed transform coefficient t′ is calculated according to

t′=2·k·Δ
where k denotes the associated transform coefficient level (transmitted quantization index). It should be noted that the term “transform coefficient level” refers to the quantized transform coefficient value, for example, it corresponds to absLevel as described in the residual_coding syntax structures hereinafter. The term “reconstructed transform coefficient” refers to the de-quantized transform coefficient value.
Q1: The reconstruction levels of the second quantizer Q1 are given by the odd integer multiples of the quantization step size Δ and, in addition, the reconstruction level equal to zero. The mapping of transform coefficient levels k to reconstructed transform coefficients t′ is specified by

t′=(2·k−sgn(k))·Δ,
where sgn(⋅) denotes the signum function

sgn(x)=(k==0?0:(k<0?−1:1)).

The scalar quantizer used (Q0 or Q1) is not explicitly signalled in the bitstream. Instead, the quantizer used for a current transform coefficient is determined by the parities of the transform coefficient levels that precede the current transform coefficient in coding/reconstruction order. For example, FIG. 6 illustrates a state transition diagram and associated quantizer selection for an approach to dependent quantization.

As illustrated in FIG. 6, the switching between the two scalar quantizers (Q0 and Q1) is realized via a state machine with four states. The state can take four different values: 0, 1, 2, 3. The state is uniquely determined by the parity of the transform coefficient level preceding the current transform coefficient in coding/reconstruction order. At the start of the inverse quantization for a transform block, the state is set equal to 0. The transform coefficients are reconstructed in scanning order (i.e., in the same order they are entropy decoded). After a current transform coefficient is reconstructed, the state is updated as shown in FIG. 6, where k denotes the value of the transform coefficient level. Note that the next state only depends on the current state and the parity (k & 1) of the current transform coefficient level k. With k representing the value of the current transform coefficient level, the state update can be written as

state=stateTransTable[state][k&1],

where stateTransTable represents the state transition table shown in FIG. 6 and the operator “&” specifies the bit-wise “and” operator in two's-complement arithmetic. Alternatively, the state transition can also be specified without a table look-up, but a 16-bit value Q StateTransTable:

state=(QStateTransTable>>((state<<2)+((k&1)<<1)))&3

If dependent quantization is used, the value of QStateTransTable is set equal to 32040. As a consequence, the state is updated using a state machine with four states. If the state for a current transform coefficient is equal to 0 or 1, the scalar quantizer Q0 is used. Otherwise (the state is equal to 2 or 3), the scalar quantizer Q1 is used. When dependent quantization is applied, the quantization step size is 2Δ.

Otherwise (conventional scalar quantization is used), the value of QStateTransTable is set equal to 0. Consequently, the state is equal to 0 for all transform coefficients. When conventional scalar quantization is applied, the quantization step size is Δ.

Note that the state is used for selecting the probability model for the sig_coeff_flag. With the approach of parameterizing the state transition table (using the 16-bit variable QstateTransTable), exactly the same context modelling can be used for the entropy coding with dependent quantization and entropy coding with conventional independent quantization.

An approach to design of the coefficient coding can involve applying dependent scalar quantization for all transform coefficients if the dependent scalar quantization is used.

In general, an aspect of the present disclosure involves providing in at least one embodiment for selectively enabling one of, or switching between, first and second quantization schemes for transform coefficient coding. In general, at least one embodiment can include switching between first and second quantization schemes based on a condition for enabling the first quantization scheme for coding a first portion or subset of a set of transform coefficients that can include less than all of the set of transform coefficients and enabling the second quantization scheme for coding a second portion or subset of the set of transform coefficients other than those included in the first subset. In general, at least one embodiment can include the condition comprising a location of the transform coefficients with respect to one or more regions of a coding block, e.g., the first portion being located in a first region corresponding to low frequency information and the second portion being located in a second region corresponding to high frequency information. In general, at least one embodiment can include the condition comprising a prediction mode of a block, wherein the prediction mode comprises one of intra-coded or inter-coded, e.g., the first portion corresponds to intra-coded information and the second portion corresponds to inter-coded information. In general, at least one embodiment can include the condition comprising a component characteristic wherein the component characteristic comprises one of luma component and chroma component, e.g., the first portion comprises luma information and the second portion comprises chroma information. In general, at least one embodiment can include the condition comprising a combination of one or more of the location of a transform coefficient and a prediction mode and a component characteristic. In general, at least one embodiment can include the condition being determined based on evaluating a coding efficiency and/or an implementation complexity.

In more detail, a codec such as that being developed by JVET may include an approach to quantization such as dependent scalar quantization that applies to all transform coefficients in the block. Dependent quantization can increase the coding efficiency through the trellis coded quantization technique. However, the complexity of dependent scalar quantization can be higher than an alternative quantization approach such as the conventional scalar quantization. Higher complexity of dependent scalar quantization can relate to, for example, more steps required in the decoding process.

Regarding the transform coefficients to be quantized, after transform the energy will be highly compacted into the top-left corner of the coding block which corresponds to a low-frequency location or region. That is, the DC coefficient and low frequency transform coefficients usually have more information and higher absolute values compared to the transform coefficients located in the high frequency regions. For transform coefficients located in the high frequency region, most of them are zeros or trivial values (1 or 2). Such trivial values can be easily coded with a low rate cost (e.g., determined based on rate-distortion optimization (RDO)) using a quantization scheme or technique such as conventional scalar quantization, and the influence of the trivial values on the sample reconstruction are not as important as the DC coefficient or low frequency transform coefficients.

In general, an aspect of at least one example of an embodiment described herein comprises selectively enabling or switching between first and second quantization schemes based on a condition, e.g., applying first and second quantization schemes to transform coefficients based on a condition such as location of the transform coefficients in a coding block (e.g., low frequency region or high frequency region frequency). In at least one embodiment, another aspect can involve deactivating, disabling, or switching from a first type of quantization, e.g., dependent scalar quantization, used for quantizing transform coefficients located in a first location or region, e.g., a low frequency region, and activating, enabling or switching to a second type of quantization, e.g., conventional scalar quantization, for quantizing transform coefficients located in a second location or region, e.g., a high frequency region, wherein the switching can be based on evaluating one or more factors, e.g., obtaining a good or acceptable or optimum trade-off between factors or characteristics such as coding complexity and efficiency.

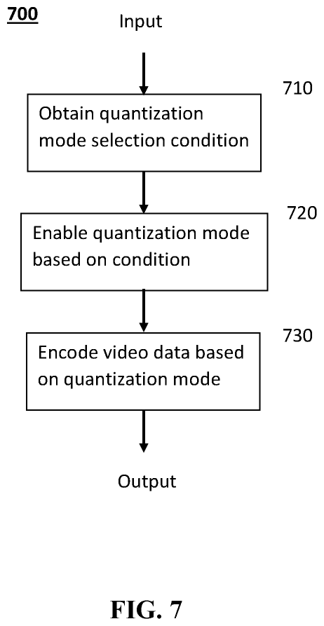

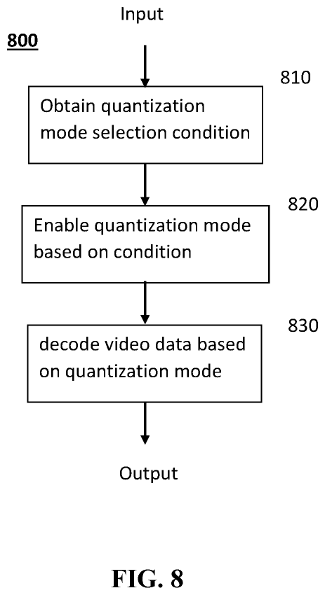

FIG. 7 and FIG. 8 illustrate, respectively, an example embodiment of an encoding method 700 and of a decoding method 800 in accordance with the present disclosure. In an encoding method 700 such as that shown in FIG. 7, a quantization mode selection condition is obtained at 710, e.g., by extracting information from the input such as a prediction mode, location in a coding block or other characteristic such as luma/chroma. At 720, a quantization mode or type of quantization, such as dependent scalar quantization or conventional scalar quantization, is enabled based on the condition obtained at 710. Then, at 730, video data are encoded based on the quantization mode or type.

Likewise, in a decoding method 800 such as that shown in FIG. 8, a quantization mode selection condition is obtained at 810, e.g., by extracting information from the input (e.g., based on syntax of a signal) such as a prediction mode, location in a coding block or other characteristic such as luma/chroma. At 820, a quantization mode or type of quantization, such as dependent scalar quantization or conventional scalar quantization, is enabled based on the condition obtained at 810. Then, at 830, video data are decoded based on the quantization mode or type.

As another example, based on the current adopted design of the coefficient coding in a codec such as that envisioned by JVET, the switching between the dependent and the conventional scalar quantization can be realized by setting the 16-bit value of QStateTransTable, which specifies the state transition table. If the value of QStateTransTable is set equal to 0, the conventional scalar quantization is used, with quantization step size equal to Δ; and if the value of QStateTransTable is set equal to 32040, then the dependent scalar quantization is used, the quantization step size is adaptively changed to 2Δ.

At least one embodiment can include deactivating dependent scalar quantization for transform coefficients located in the high frequency regions, wherein the value of QStateTransTable might be set based on the position of the sub-block, which can also be called “coefficient group (CG)”. Then, one can apply a variant such as the following:
only activate dependent scalar quantization for the first sub-block, which contains the DC level; or
only activate dependent scalar quantization for the first sub-block and one or more additional sub-blocks located in the top-left of the coding block, which contain the DC level and low frequency coefficients. The number of sub-blocks in which dependent scalar quantization is applied (e.g., referred to hereinafter as a parameter or value named “DSQSwitchPoint”) can be one predefined value, or a value DSQSwitchPoint, which depends on a factor such as the size of the coding block (width and height).

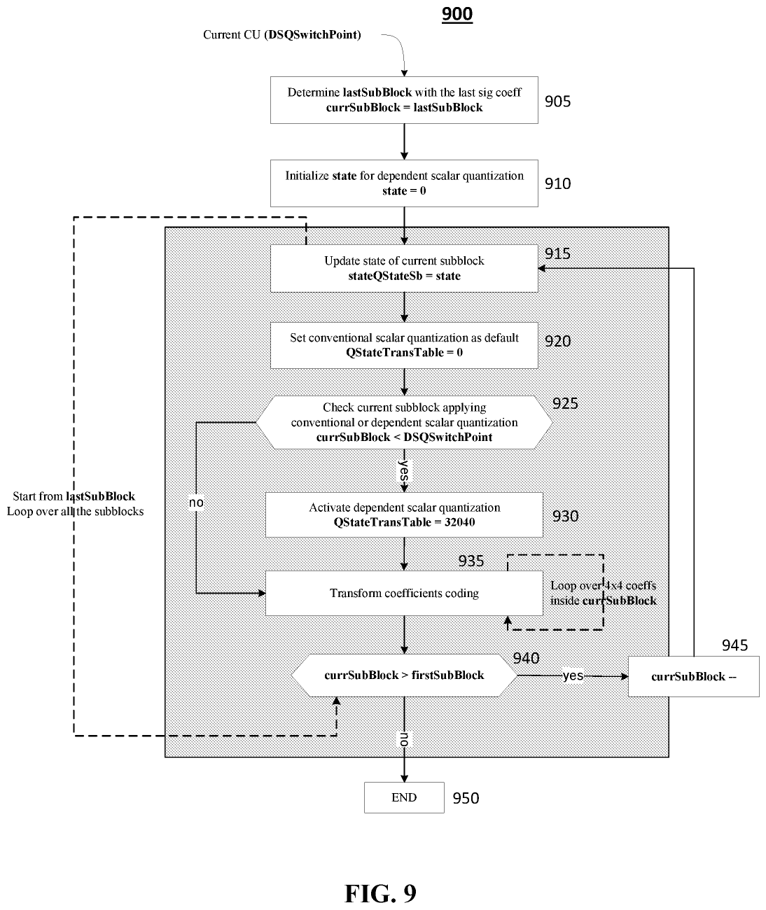

FIG. 9 depicts a flow chart 900 illustrating an example of an embodiment involving activating dependent scalar quantization for several sub-blocks whose indexes are smaller than the predefined DSQSwitchPoint. In conjunction, another aspect of present embodiments involves providing for encoding and/or decoding signal syntax and/or a bitstream including such syntax to enable switching between quantization schemes as described herein. An example of such syntax is shown in Table 1 appended to this document. Details in Table 1 correspond to the example embodiment described above and illustrated in FIG. 9. In Table 1, for the purpose of illustration, the different passes over the scan positions are labeled “first pass”, “second pass”, “third pass” and “fourth pass”. The shaded portions of Table 1 illustrate an example of syntax used for switching between transform coefficient coding for dependent and conventional scalar quantization.

One or more embodiments described above can include activating or enabling dependent scalar quantization for transform coefficients located in low frequency regions. A variant can include deactivating dependent scalar quantization for transform coefficients located in the low frequency regions, for example if evaluation of coding efficiency and/or complexity indicate doing so would be advantageous.

In general, another aspect of at least one embodiment can involve prediction mode, e.g., intra-coding or inter-coding. For example, intra-coded blocks usually contain more residual information to code than inter-coded blocks and, therefore, dependent scalar quantization can be more useful for intra-coded blocks.

In at least one other embodiment, a quantization mode or type such as dependent scalar quantization can be enabled or activated based on a condition such as prediction mode. For example, a prediction mode condition indicating intra-coded blocks may enable a quantization type or mode such as dependent scalar quantization while a condition indicating for inter-coded blocks, can be a basis for switching quantization mode, e.g., to a conventional scalar quantization instead. Doing so may be based on evaluating factors such as coding complexity and efficiency, e.g., to achieve a trade-off among such factors that may be suitable, good or optimum for a particular situation or embodiment.

A variant to the described embodiment involving prediction mode may comprise switching between quantization modes or types to, for example, deactivate or disable a quantization type such as dependent scalar quantization for intra-coded blocks, while enabling or activating it for inter-coded blocks.

In general, another aspect of at least one embodiment can involve selecting or switching quantization mode or type based on condition comprising a component characteristic such as luma/chroma or other color components. The human visual system is less sensitive to color than it is to structure and texture information. Therefore, in many application scenarios, it is more important to provide a high resolution Luma component than to provide such detail for the Chroma components. During the video compression, reducing the data loss of Luma samples is more necessary compared to the Chroma samples. In order to mitigate the information loss, fine and accurate quantization is very essential. Accordingly, in at least one example of an embodiment, a type of quantization such as dependent scalar quantization can be activated or enabled based on a condition comprising a component characteristic. For example, dependent scalar quantization can be enabled or activated based on the condition indicating a Luma component and, for chroma components, switching to the conventional scalar quantization instead. Doing so may be based on evaluating factors such as coding complexity and efficiency, e.g., to achieve a trade-off among such factors that may be suitable, good or optimum for a particular situation or embodiment. A variant can comprise the condition being evaluated to deactivate the dependent scalar quantization for a Luma component, while only activating it for Chroma components.

The above-described variants may be viewed as exclusive in that a particular system having a specific or fixed hardware codec embodiment may implement one of the embodiments, features, aspects or variants to the exclusion of the others. Alternatively, certain systems may be inclusive of more than one of such variants. For example, various combinations of features and aspects described herein are envisioned. Also, a system may be reconfigurable, e.g., include a capability for reconfiguration of hardware and/or software, based on factors such as, but not limited to, content to be processed, power consumption control, performance (speed, latency), coding complexity, coding efficiency, etc. In such systems, the reconfiguration capability may include selectively enabling one or more of a plurality of variants such as those described.

Various methods are described above, and each of the methods comprises one or more steps or actions for achieving the described method. Unless a specific order of steps or actions is required for proper operation of the method, the order and/or use of specific steps and/or actions may be modified or combined.

Various numeric values are used in the present application, for example, the number of intra prediction modes (35, or 67), or the number of transform subsets (3). It should be noted that the specific values are for exemplary purposes and the present embodiments are not limited to these specific values.

In the above, various embodiments are described with respect to HEVC, or JEM. For example, various examples of aspects and embodiments in accordance with the present disclosure may be used to modify one or more aspects of an encoder and/or decoder such as in a JEM or HEVC encoder and decoder illustrated in FIG. 1 and FIG. 2, respectively. As an example, aspects and embodiments described herein may modify quantization module 130 and/or inverse quantization module 140 and/or entropy coding module 145 in an encoder such as that illustrated in FIG. 1 and/or may modify inverse quantization module 240 and/or entropy decoding module 220 in a decoder such as that illustrated in FIG. 2. However, the present embodiments are not limited to JEM or HEVC, and can be applied to other standards, recommendations, and extensions thereof.

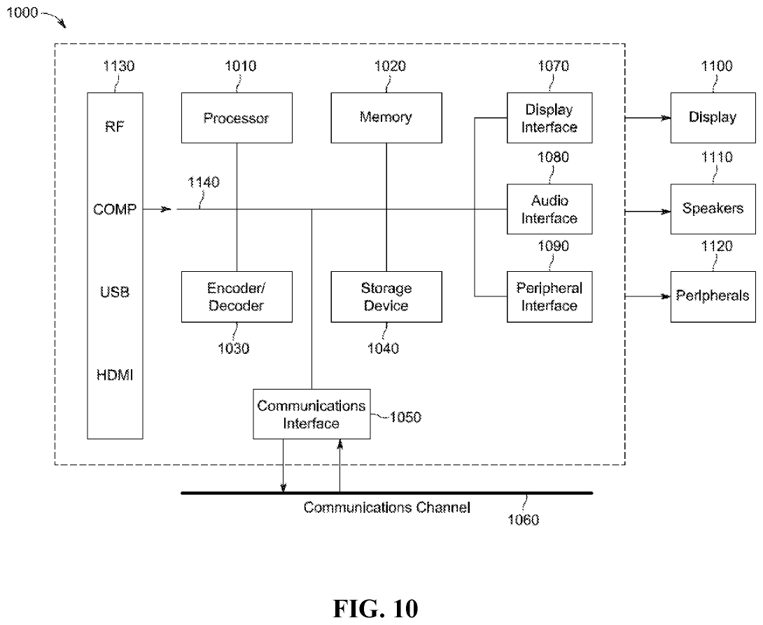

FIG. 10 illustrates a block diagram of an example of a system in which various aspects and embodiments can be implemented. System 1000 can be embodied as a device including the various components described below and is configured to perform one or more of the aspects described in this document. Examples of such devices, include, but are not limited to, various electronic devices such as personal computers, laptop computers, smartphones, tablet computers, digital multimedia set top boxes, digital television receivers, personal video recording systems, connected home appliances, and servers. Elements of system 1000, singly or in combination, can be embodied in a single integrated circuit, multiple ICs, and/or discrete components. For example, in at least one embodiment, the processing and encoder/decoder elements of system 1000 are distributed across multiple ICs and/or discrete components. In various embodiments, the system 1000 is communicatively coupled to other similar systems, or to other electronic devices, via, for example, a communications bus or through dedicated input and/or output ports. In various embodiments, the system 1000 is configured to implement one or more of the aspects described in this document.

The system 1000 includes at least one processor 1010 configured to execute instructions loaded therein for implementing, for example, the various aspects described in this document. Processor 1010 can include embedded memory, input output interface, and various other circuitries as known in the art. The system 1000 includes at least one memory 1020 (e.g., a volatile memory device, and/or a non-volatile memory device). System 1000 includes a storage device 1040, which can include non-volatile memory and/or volatile memory, including, but not limited to, EEPROM, ROM, PROM, RAM, DRAM, SRAM, flash, magnetic disk drive, and/or optical disk drive. The storage device 1040 can include an internal storage device, an attached storage device, and/or a network accessible storage device, as non-limiting examples.

System 1000 includes an encoder/decoder module 1030 configured, for example, to process data to provide an encoded video or decoded video, and the encoder/decoder module 1030 can include its own processor and memory. The encoder/decoder module 1030 represents module(s) that can be included in a device to perform the encoding and/or decoding functions. As is known, a device can include one or both of the encoding and decoding modules. Additionally, encoder/decoder module 1030 can be implemented as a separate element of system 1000 or can be incorporated within processor 1010 as a combination of hardware and software as known to those skilled in the art.

Program code to be loaded onto processor 1010 or encoder/decoder 1030 to perform the various aspects described in this document can be stored in storage device 1040 and subsequently loaded onto memory 1020 for execution by processor 1010. In accordance with various embodiments, one or more of processor 1010, memory 1020, storage device 1040, and encoder/decoder module 1030 can store one or more of various items during the performance of the processes described in this document. Such stored items can include, but are not limited to, the input video, the decoded video or portions of the decoded video, the bitstream or signal, matrices, variables, and intermediate or final results from the processing of equations, formulas, operations, and operational logic.

In several embodiments, memory inside of the processor 1010 and/or the encoder/decoder module 1030 is used to store instructions and to provide working memory for processing that is needed during encoding or decoding. In other embodiments, however, a memory external to the processing device (for example, the processing device can be either the processor 1010 or the encoder/decoder module 1030) is used for one or more of these functions. The external memory can be the memory 1020 and/or the storage device 1040, for example, a dynamic volatile memory and/or a non-volatile flash memory. In several embodiments, an external non-volatile flash memory is used to store the operating system of a television. In at least one embodiment, a fast external dynamic volatile memory such as a RAM is used as working memory for video coding and decoding operations, such as for MPEG-2, HEVC, or VVC (Versatile Video Coding).

The input to the elements of system 1000 can be provided through various input devices as indicated in block 1130. Such input devices include, but are not limited to, (i) an RF portion that receives an RF signal transmitted, for example, over the air by a broadcaster, (ii) a Composite input terminal, (iii) a USB input terminal, and/or (iv) an HDMI input terminal.

In various embodiments, the input devices of block 1130 have associated respective input processing elements as known in the art. For example, the RF portion can be associated with elements for (i) selecting a desired frequency (also referred to as selecting a signal, or band-limiting a signal to a band of frequencies), (ii) downconverting the selected signal, (iii) band-limiting again to a narrower band of frequencies to select (for example) a signal frequency band which can be referred to as a channel in certain embodiments, (iv) demodulating the downconverted and band-limited signal, (v) performing error correction, and (vi) demultiplexing to select the desired stream of data packets. The RF portion of various embodiments includes one or more elements to perform these functions, for example, frequency selectors, signal selectors, band-limiters, channel selectors, filters, downconverters, demodulators, error correctors, and demultiplexers. The RF portion can include a tuner that performs various of these functions, including, for example, downconverting the received signal to a lower frequency (for example, an intermediate frequency or a near-baseband frequency) or to baseband. In one set-top box embodiment, the RF portion and its associated input processing element receives an RF signal transmitted over a wired (for example, cable) medium, and performs frequency selection by filtering, downconverting, and filtering again to a desired frequency band. Various embodiments rearrange the order of the above-described (and other) elements, remove some of these elements, and/or add other elements performing similar or different functions. Adding elements can include inserting elements in between existing elements, for example, inserting amplifiers and an analog-to-digital converter. In various embodiments, the RF portion includes an antenna.

Additionally, the USB and/or HDMI terminals can include respective interface processors for connecting system 1000 to other electronic devices across USB and/or HDMI connections. It is to be understood that various aspects of input processing, for example, Reed-Solomon error correction, can be implemented, for example, within a separate input processing IC or within processor 1010. Similarly, aspects of USB or HDMI interface processing can be implemented within separate interface ICs or within processor 1010. The demodulated, error corrected, and demultiplexed stream is provided to various processing elements, including, for example, processor 1010, and encoder/decoder 1030 operating in combination with the memory and storage elements to process the datastream for presentation on an output device.

Various elements of system 1000 can be provided within an integrated housing, Within the integrated housing, the various elements can be interconnected and transmit data therebetween using suitable connection arrangement 1140, for example, an internal bus as known in the art, including the I2C bus, wiring, and printed circuit boards.

The system 1000 includes communication interface 1050 that enables communication with other devices via communication channel 1060. The communication interface 1050 can include, but is not limited to, a transceiver configured to transmit and to receive data over communication channel 1060. The communication interface 1050 can include, but is not limited to, a modem or network card and the communication channel 1060 can be implemented, for example, within a wired and/or a wireless medium.

Data is streamed to the system 1000, in various embodiments, using a Wi-Fi network such as IEEE 802.11. The Wi-Fi signal of these embodiments is received over the communications channel 1060 and the communications interface 1050 which are adapted for Wi-Fi communications. The communications channel 1060 of these embodiments is typically connected to an access point or router that provides access to outside networks including the Internet for allowing streaming applications and other over-the-top communications. Other embodiments provide streamed data to the system 1000 using a set-top box that delivers the data over the HDMI connection of the input block 1130. Still other embodiments provide streamed data to the system 1000 using the RF connection of the input block 1130.

The system 1000 can provide an output signal to various output devices, including a display 1100, speakers 1110, and other peripheral devices 1120. The other peripheral devices 1120 include, in various examples of embodiments, one or more of a stand-alone DVR, a disk player, a stereo system, a lighting system, and other devices that provide a function based on the output of the system 1000. In various embodiments, control signals are communicated between the system 1000 and the display 1100, speakers 1110, or other peripheral devices 1120 using signaling such as AV.Link, CEC, or other communications protocols that enable device-to-device control with or without user intervention. The output devices can be communicatively coupled to system 1000 via dedicated connections through respective interfaces 1070, 1080, and 1090. Alternatively, the output devices can be connected to system 1000 using the communications channel 1060 via the communications interface 1050. The display 1100 and speakers 1110 can be integrated in a single unit with the other components of system 1000 in an electronic device, for example, a television. In various embodiments, the display interface 1070 includes a display driver, for example, a timing controller (T Con) chip.

The display 1100 and speaker 1110 can alternatively be separate from one or more of the other components, for example, if the RF portion of input 1130 is part of a separate set-top box. In various embodiments in which the display 1100 and speakers 1110 are external components, the output signal can be provided via dedicated output connections, including, for example, HDMI ports, USB ports, or COMP outputs.

The embodiments can be carried out by computer software implemented by the processor 1010 or by hardware, or by a combination of hardware and software. As a non-limiting example, the embodiments can be implemented by one or more integrated circuits. The memory 1020 can be of any type appropriate to the technical environment and can be implemented using any appropriate data storage technology, such as optical memory devices, magnetic memory devices, semiconductor-based memory devices, fixed memory, and removable memory, as non-limiting examples. The processor 1010 can be of any type appropriate to the technical environment, and can encompass one or more of microprocessors, general purpose computers, special purpose computers, and processors based on a multi-core architecture, as non-limiting examples.

Various generalized as well as particularized embodiments are also supported and contemplated throughout this disclosure. Examples of embodiments in accordance with the present disclosure include but are not limited to the following.

In general, at least one example of an embodiment can involve a method for video encoding, comprising: obtaining a quantization mode selection condition; selecting a first quantization mode for processing a first portion of a set of transform coefficients based on the quantization mode selection condition; selecting a second quantization mode for processing a second portion of the set of transform coefficients based on the quantization mode selection condition; and encoding the video based on the processed first and second portions of the set of transform coefficients.

In general, at least one example of an embodiment can involve a method for video decoding, comprising: obtaining a quantization mode selection condition; selecting a first quantization mode for processing a first portion of a set of transform coefficients based on the quantization mode selection condition; selecting a second quantization mode for processing a second portion of the set of transform coefficients based on the quantization mode selection condition; and decoding the video based on the processed first and second portions of the set of transform coefficients.

In general, at least one example of an embodiment can involve an apparatus for video encoding, comprising one or more processors, wherein the one or more processors are configured to: obtain a quantization mode selection condition; select a first quantization mode for processing a first portion of a set of transform coefficients based on the quantization mode selection condition; select a second quantization mode for processing a second portion of the set of transform coefficients based on the quantization mode selection condition; and encode the video based on the processed first and second portions of the set of transform coefficients.

In general, at least one example of an embodiment can involve an apparatus for video decoding, comprising one or more processors, wherein the one or more processors are configured to: obtain a quantization mode selection condition; select a first quantization mode for processing a first portion of a set of transform coefficients based on the quantization mode selection condition; select a second quantization mode for processing a second portion of the set of transform coefficients based on the quantization mode selection condition; and decode the video based on the processed first and second portions of the set of transform coefficients.

In general, at least one example of an embodiment can involve a method for video encoding, comprising: obtaining a quantization mode selection condition comprising a prediction mode of a block; selecting a first quantization mode for processing a first portion of a set of transform coefficients based on the quantization mode selection condition; selecting a second quantization mode for processing a second portion of the set of transform coefficients based on the quantization mode selection condition; and encoding the video based on the processed first and second portions of the set of transform coefficients.

In general, at least one example of an embodiment can involve a method for video decoding, comprising: obtaining a quantization mode selection condition comprising a prediction mode of a block; selecting a first quantization mode for processing a first portion of a set of transform coefficients based on the quantization mode selection condition; selecting a second quantization mode for processing a second portion of the set of transform coefficients based on the quantization mode selection condition; and decoding the video based on the processed first and second portions of the set of transform coefficients.

In general, at least one example of an embodiment can involve an apparatus for video encoding, comprising one or more processors, wherein the one or more processors are configured to: obtain a quantization mode selection condition comprising a prediction mode of a block; select a first quantization mode for processing a first portion of a set of transform coefficients based on the quantization mode selection condition; select a second quantization mode for processing a second portion of the set of transform coefficients based on the quantization mode selection condition; and encode the video based on the processed first and second portions of the set of transform coefficients.

In general, at least one example of an embodiment can involve an apparatus for video decoding, comprising one or more processors, wherein the one or more processors are configured to: obtain a quantization mode selection condition comprising a prediction mode of a block; select a first quantization mode for processing a first portion of a set of transform coefficients based on the quantization mode selection condition; select a second quantization mode for processing a second portion of the set of transform coefficients based on the quantization mode selection condition; and decode the video based on the processed first and second portions of the set of transform coefficients.

In general, at least one example of an embodiment can involve a method or apparatus as described herein, wherein at least one syntax element is provided to indicate the quantization mode selection condition.

In general, at least one example of an embodiment can involve a method or apparatus as described herein, wherein a first quantization mode is different than a second quantization mode.

In general, at least one example of an embodiment can involve a method or apparatus as described herein, wherein a first quantization mode is dependent scalar quantization.

In general, at least one example of an embodiment can involve a method or apparatus as described herein, wherein a dependent scalar quantization depends on a value of a previous transform coefficient in reconstruction order.

In general, at least one example of an embodiment can involve a method or apparatus as described herein, wherein a second quantization mode is not dependent scalar quantization.

In general, at least one example of an embodiment can involve a method or apparatus as described herein, wherein a dependent scalar quantization is applied to transform coefficients in a first portion which has lower frequency than a second portion.

In general, at least one example of an embodiment can involve a method or apparatus as described herein, wherein the not dependent scalar quantization is applied to transform coefficients in the second portion which has higher frequency than the first portion.

In general, at least one example of an embodiment can involve a method or apparatus as described herein, wherein a quantization mode selection condition depends on one or more of: 1) a location in a coding block, 2) a prediction mode of a block, or 3) a component characteristic of a block.

In general, at least one example of an embodiment can involve a method or apparatus as described herein, wherein a prediction mode comprises whether a block being encoded or decoded is intra or inter coded.

In general, at least one example of an embodiment can involve a method or apparatus as described herein, wherein a component characteristic of a block comprises whether the block being encoded or decoded is a luma component or a chroma component of the video.

In general, at least one example of an embodiment can involve a bitstream comprising video, wherein the bitstream is formed by: obtaining a quantization mode selection condition; selecting a first quantization mode for processing a first portion of a set of transform coefficients based on the quantization mode selection condition; selecting a second quantization mode for processing a second portion of the set of transform coefficients based on the quantization mode selection condition; and encoding the video into the bitstream based on the processed first and second portions of the set of transform coefficients.

In general, at least one example of an embodiment can involve a non-transitory computer readable medium containing data content generated according to one or more embodiments of methods or apparatus as described herein.

In general, at least one example of an embodiment can involve a computer program product comprising instructions for performing one or more methods as described herein.

In general, at least one example of an embodiment can involve a signal comprising data generated according to one or more methods as described herein.

In general, at least one example of an embodiment can involve a device comprising: an apparatus as described herein; and at least one of (i) an antenna configured to receive a signal, the signal including data representative of the image information, (ii) a band limiter configured to limit the received signal to a band of frequencies that includes the data representative of the image information, and (iii) a display configured to display an image from the image information.

In general, at least one example of an embodiment can involve a device, wherein the device comprises one of a television, a television signal receiver, a set-top box, a gateway device, a mobile device, a cell phone, a tablet, or other electronic device.

Throughout this disclosure, various implementations involve decoding. “Decoding”, as used in this application, can encompass all or part of the processes performed, for example, on a received encoded sequence in order to produce a final output suitable for display. In various embodiments, such processes include one or more of the processes typically performed by a decoder, for example, entropy decoding, inverse quantization, inverse transformation, and differential decoding. In various embodiments, such processes also, or alternatively, include processes performed by a decoder of various implementations described in this application, for example, extracting a picture from a tiled (packed) picture, determining an upsample filter to use and then upsampling a picture, and flipping a picture back to its intended orientation.

As further examples, in one embodiment “decoding” refers only to entropy decoding, in another embodiment “decoding” refers only to differential decoding, and in another embodiment “decoding” refers to a combination of entropy decoding and differential decoding. Whether the phrase “decoding process” is intended to refer specifically to a subset of operations or generally to the broader decoding process will be clear based on the context of the specific descriptions and is believed to be well understood by those skilled in the art.

Also, various implementations involve encoding. In an analogous way to the above discussion about “decoding”, “encoding” as used in this application can encompass all or part of the processes performed, for example, on an input video sequence in order to produce an encoded bitstream or signal. In various embodiments, such processes include one or more of the processes typically performed by an encoder, for example, partitioning, differential encoding, transformation, quantization, and entropy encoding. In various embodiments, such processes also, or alternatively, include processes performed by an encoder of various implementations described in this application.

As further examples, in one embodiment “encoding” refers only to entropy encoding, in another embodiment “encoding” refers only to differential encoding, and in another embodiment “encoding” refers to a combination of differential encoding and entropy encoding. Whether the phrase “encoding process” is intended to refer specifically to a subset of operations or generally to the broader encoding process will be clear based on the context of the specific descriptions and is believed to be well understood by those skilled in the art.

Note that the syntax elements as used herein are descriptive terms. As such, they do not preclude the use of other syntax element names.

When a figure is presented as a flow diagram, it should be understood that it also provides a block diagram of a corresponding apparatus. Similarly, when a figure is presented as a block diagram, it should be understood that it also provides a flow diagram of a corresponding method/process.

Various embodiments refer to rate distortion optimization. In particular, during the encoding process, the balance or trade-off between the rate and distortion is usually considered, often given the constraints of computational complexity. The rate distortion optimization is usually formulated as minimizing a rate distortion function, which is a weighted sum of the rate and of the distortion. There are different approaches to solve the rate distortion optimization problem. For example, the approaches can be based on an extensive testing of all encoding options, including all considered modes or coding parameters values, with a complete evaluation of their coding cost and related distortion of the reconstructed signal after coding and decoding. Faster approaches can also be used, to save encoding complexity, in particular with computation of an approximated distortion based on the prediction or the prediction residual signal, not the reconstructed one. Mix of these two approaches can also be used, such as by using an approximated distortion for only some of the possible encoding options, and a complete distortion for other encoding options. Other approaches only evaluate a subset of the possible encoding options. More generally, many approaches employ any of a variety of techniques to perform the optimization, but the optimization is not necessarily a complete evaluation of both the coding cost and related distortion.

The implementations and aspects described herein can be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or program). An apparatus can be implemented in, for example, appropriate hardware, software, and firmware. The methods can be implemented in, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this document are not necessarily all referring to the same embodiment.

Additionally, this document may refer to “obtaining” various pieces of information. Obtaining the information can include one or more of, for example, determining the information, estimating the information, calculating the information, predicting the information, or retrieving the information from memory.

Further, this document may refer to “accessing” various pieces of information. Accessing the information can include one or more of, for example, receiving the information, retrieving the information (for example, from memory), storing the information, moving the information, copying the information, calculating the information, determining the information, predicting the information, or estimating the information.

Additionally, this document may refer to “receiving” various pieces of information. Receiving is, as with “accessing”, intended to be a broad term. Receiving the information can include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

Also, as used herein, the word “signal” refers to, among other things, indicating something to a corresponding decoder. For example, in certain embodiments the encoder signals a particular one of a plurality of parameters for refinement. In this way, in an embodiment the same parameter is used at both the encoder side and the decoder side. Thus, for example, an encoder can transmit (explicit signaling) a particular parameter to the decoder so that the decoder can use the same particular parameter. Conversely, if the decoder already has the particular parameter as well as others, then signaling can be used without transmitting (implicit signaling) to simply allow the decoder to know and select the particular parameter. By avoiding transmission of any actual functions, a bit savings is realized in various embodiments. It is to be appreciated that signaling can be accomplished in a variety of ways. For example, one or more syntax elements, flags, and so forth are used to signal information to a corresponding decoder in various embodiments. While the preceding relates to the verb form of the word “signal”, the word “signal” can also be used herein as a noun.

As will be evident to one of ordinary skill in the art, implementations can produce a variety of signals formatted to carry information that can be, for example, stored or transmitted. The information can include, for example, instructions for performing a method, or data produced by one of the described implementations. For example, a signal can be formatted to carry the bitstream or signal of a described embodiment. Such a signal can be formatted, for example, as an electromagnetic wave (for example, using a radio frequency portion of spectrum) or as a baseband signal. The formatting can include, for example, encoding a data stream and modulating a carrier with the encoded data stream. The information that the signal carries can be, for example, analog or digital information. The signal can be transmitted over a variety of different wired or wireless links, as is known. The signal can be stored on a processor-readable medium.

Various embodiments have been described. Embodiments may include any of the following features or entities, alone or in any combination, across various different claim categories and types:
Providing a method for video encoding comprising obtaining a quantization mode selection condition, selecting a first quantization mode based on the condition for processing a first portion of a set of transform coefficients, selecting a second quantization mode based on the condition for processing a second portion of the set of transform coefficients, and encoding video information based on the processing of the first and second portions.
Providing apparatus for video encoding comprising one or more processors configured for obtaining a quantization mode selection condition, selecting a first quantization mode based on the condition for processing a first portion of a set of transform coefficients, selecting a second quantization mode based on the condition for processing a second portion of the set of transform coefficients, and encoding video information based on the processing of the first and second portions.
Providing a method for video decoding comprising obtaining a quantization mode selection condition, selecting a first quantization mode based on the condition for processing a first portion of a set of transform coefficients, selecting a second quantization mode based on the condition for processing a second portion of the set of transform coefficients, and decoding video information based on the processing of the first and second portions.
Providing apparatus for video decoding comprising one or more processors configured to obtaining a quantization mode selection condition, selecting a first quantization mode based on the condition for processing a first portion of a set of transform coefficients, selecting a second quantization mode based on the condition for processing a second portion of the set of transform coefficients, and decoding video information based on the processing of the first and second portions.
Providing for one or more syntax elements providing an indication of a quantization mode selection condition enabling selecting a first quantization mode based on the condition for processing a first portion of a set of transform coefficients, selecting a second quantization mode based on the condition for processing a second portion of the set of transform coefficients, and encoding and/or decoding video information based on the processing of the first and second portions.
Providing for a bitstream, wherein the bitstream is formed by including information indicating a quantization mode selection condition enabling selecting a first quantization mode based on the condition for processing a first portion of a set of transform coefficients, selecting a second quantization mode based on the condition for processing a second portion of the set of transform coefficients, and encoding and/or decoding video information based on the processing of the first and second portions.
Providing for video encoding and/or decoding comprising switching between first and second quantization methods for processing first and second portions of a set of transform coefficients.
Providing for video encoding and/or decoding comprising selectively enabling and/or switching between dependent scalar quantization and conventional scalar quantization for processing first and second portions of a set of transform coefficients.
Providing for video encoding and/or decoding comprising selectively enabling, based on a condition, one of first and second quantization schemes for processing a set of transform coefficients, wherein the condition comprises one of a location of the transform coefficients in a coding block, and/or a prediction mode of a block, and/or a component characteristic.
Providing for video encoding and/or decoding comprising selectively enabling, based on a condition, one of first and second quantization schemes wherein the condition comprises a location in a coding block, and wherein the location comprises a low frequency region or a high frequency region.
Providing for video encoding and/or decoding comprising selectively enabling, based on a condition, one of first and second quantization schemes wherein the condition comprises a location in a coding block, and wherein the location comprises a low frequency region or a high frequency region, and wherein selectively enabling comprises enabling dependent scalar quantization for transform coefficients located in the low-frequency region and enabling conventional scalar quantization for transform coefficients located in the high-frequency region.
Providing for video encoding and/or decoding comprising selectively enabling, based on a condition, one of first and second quantization schemes wherein the condition comprises a prediction mode of a coding block, and wherein the prediction mode comprises an intra-coding mode or an inter-coding mode, and wherein selectively enabling comprises enabling dependent scalar quantization for an intra-coded block and enabling conventional scalar quantization for an inter-coded block.
Providing for video encoding and/or decoding comprising selectively enabling, based on a condition, one of first and second quantization schemes wherein the condition comprises a component characteristic, and wherein the component characteristic comprises one of luma or chroma, and wherein selectively enabling comprises enabling dependent scalar quantization for a luma component and enabling conventional scalar quantization for a chroma component.
Providing for one or more syntax elements providing an indication of a quantization mode selection condition enabling selecting a first quantization mode based on the condition for processing a first portion of a set of transform coefficients, selecting a second quantization mode based on the condition for processing a second portion of the set of transform coefficients, and encoding and/or decoding video information based on the processing of the first and second portions.
A bitstream or signal that includes one or more of the described syntax elements, or variations thereof.
Creating and/or transmitting and/or receiving and/or decoding a bitstream or signal that includes one or more of the described syntax elements, or variations thereof.
A TV, set-top box, cell phone, tablet, or other electronic device that performs video encoding and/or decoding according to any of the embodiments described, and that displays (e.g. using a monitor, screen, or other type of display) a resulting image.
A TV, set-top box, cell phone, tablet, or other electronic device that tunes (e.g. using a tuner) a channel to receive a signal including an encoded image, and performs video encoding and/or decoding according to any of the embodiments described.
A TV, set-top box, cell phone, tablet, or other electronic device that receives (e.g. using an antenna) a signal over the air that includes an encoded image, and performs video encoding and/or decoding according to any of the embodiments described.
A computer program product storing program code that, when executed by a computer implements video encoding and/or decoding in accordance with any of the embodiments described.
A non-transitory computer readable medium including executable program instructions causing a computer executing the instructions to implement video encoding and/or decoding in accordance with any of the embodiments described.
A computer readable storage medium having stored thereon a bitstream generated in accordance with one or more aspects and/or embodiments described herein.
A method and apparatus for transmitting the bitstream generated in accordance with one or more aspects and/or embodiments described herein.

Various other generalized as well as particularized embodiments are also supported and contemplated throughout this disclosure.

TABLE 1

| residual_coding( x0, y0, log2TbWidth, log2TbHeight, cIdx, [symbol] { | Descriptor |
|---|---|
| if( transform_skip_enabled_flag && ( cIdx != \| \| cu_mts_flag[ x0 ][ y0 ] = = 0) && | |
| ( log2TbWidth <= 2) && ( log2TbHeight <= 2 ) ) | |
| transform_skip_flag[ x0 ][ y0 i][ cIdx ] | ae(v) |
| last_sig_coeff_x_prefix | ae(v) |
| last_sig_coeff_y_prefix | ae(v) |
| if( last_sig_coeff_x_prefix > 3 ) | |
| last_sig_coeff_x_suffix | ae(v) |
| if( last_sig_coeff_y_prefix > 3) | |
| last_sig_coeff_y_suffix | ae(v) |
| log2SbSize = ( Min( log2TbWidth, log2TbHeight ) < 2 ? 1 : 2) | |
| numSbCoeff = 1 << ( log2SbSize << 1 ) | |
| lastScanPos = numSbCoeff | |
| lastSubBlock = ( 1 << ( log2TbWidth + log2TbHeight − 2 * log2SbSize ) ) − 1 | |
| do { | |
| if( lastScanPos == 0) { | |
| lastScanPos = numSbCoeff | |
| lastSubBlock− − | |
| } | |
| lastScanPos− − | |
| xS = DiagScanOrder[ log2TbWidth − log2SbSize ][ log2TbHeight − log2SbSize ] | |
| [ lastSubBlock ][ 0 ] | |
| yS = DiagScanOrder[ log2TbWidth − log2SbSize ][ log2TbHeight − log2SbSize ] | |
| [ lastSubBlock ][ 1 ] | |
| xC = ( xS << log2SbSize ) + | |
| DiagScanOrder[ log2SbSize ][ log2SbSize ][ lastScanPos ][ 0 ] in | |
| yC = ( yS << log2SbSize ) + | |
| DiagScanOrder[ log2SbSize ][ log2SbSize ][ lastScanPos ][ 1 ] in | |
| } while( ( xC != LastSignificantCoeffX ) \| \| ( yC != LastSignificantCoeffY ) ) | |
| numSigCoeff = 0 | |
| state = 0 | |
| for( i = lastSubBlock; i >= 0; i− − ) { | |
| startQStateSb = state | |
| [symbol] | |
| [symbol] | |
| [symbol] | |
| xS = DiagScanOrder[ log2TbWidth − log2SbSize ][ log2TbHeight − log2SbSize ] | |
| [ lastSubBlock ][ 0 ] | |
| yS = DiagScanOrder[ log2TbWidth − log2SbSize ][ log2TbHeight − log2SbSize ] | |
| [ lastSubBlock ][ 1 ] | |
| inferSbDcSigCoeffFlag = 0 | |
| if( ( i < lastSubBlock ) && ( i > 0 ) ) { | |
| coded_sub_block_flag[ xS ][ yS ] | ae(v) |
| inferSbDcSigCoeffFlag = 1 | |
| } | |
| firstSigScanPosSb = numSbCoeff | |
| lastSigScanPosSb = −1 | |
| remBinsPass1 = ( log2SbSize < 2 ? 6 : 28 ) | |
| remBinsPass2 = ( log2SbSize < 2 ? 2 : 4 ) | |
| firstPosMode0 = ( i = = lastSubBlock ? lastScanPos − 1: numSbCoeff − 1) | |
| firstPosMode1 = −1 | |
| firstPosMode2 = −1 | |
| //==== first pass: sig, gt1, par ==== | |
| for( n = firstPosMode0; n >= 0 && remBinsPass1 >= 3; n− − ) { | |
| xC = ( xS << log2SbSize ) + DiagScanOrder[ log2SbSize ][ log2SbSize ][ n ][ 0 ] | |
| yC = ( yS << log2SbSize ) + DiagScanOrder[ log2SbSize ][ log2SbSize ][ n ][ 1 ] | |
| if( coded_sub_block_flag[ xS ][ yS ] && ( n > 0 \| \| !inferSbDcSigCoeffFlag ) ) { | |
| sig_coeff_flag[ xC ][ yC ] | ae(v) |
| remBinsPass 1− − | |
| if( sig_coeff flag[ xC ][ yC ] ) | |
| inferSbDcSigCoeffFlag = 0 | |
| } | |
| if( sig_coeff_flag[ xC ][ yC ] ) { | |
| numSigCoeff++ | |
| abs_level_gt1_flag[ n ] | ae(v) |
| remBinsPass1− − | |
| if( abs_level_gt1_flag[ n ] ) { | |
| par_level_flag[ n ] | |
| remBinsPass1− − | |
| if( remBinsPass2 > 0 ) { | |
| remBinsPass2− − | |
| if( remBinsPass2 = = 0 ) | |
| firstPosMode1 = n − 1 | |
| } | |
| } | |
| if( lastSigScanPosSb == −1 ) | |
| lastSigScanPosSb = n | |
| firstSigScanPosSb = n | |
| } | |
| AbsLevelPass1[ xC ][ yC ] = | |
| sig_coeff flag[ xC ][ yC ] + par_level_flag[ n ] + abs_level_gt1_flag[ n ] | |
| if( dep_quant_enabled_flag ) | |
| [symbol] [symbol] | |
| firstPosMode2 = n − 1 | |
| } | |
| if( firstPosMode1 < firstPosMode2 ) | |
| firstPosMode1 = firstPosMode2 | |
| //==== second pass: gt2 ==== | |
| for( n = numSbCoeff − 1; n > firstPosMode1; n− −) { | |
| if( abs_level_gt1_flag[ n ] ) | |
| abs_level_gt2_flag[ n ] | ae(v) |
| } | |
| //==== third pass: bypass bins of remainder ==== | |
| for( n = numSbCoeff − 1; n > firstPosMode1; n− − ) { | |
| xC = ( xS << log2SbSize ) + DiagScanOrder[ log2SbSize ][ log2SbSize ][ n ][ 0 ] | |
| yC = ( yS << log2SbSize ) + DiagScanOrder[ log2SbSize ][ log2SbSize ][ n ][ 1 ] | |
| if( abs_level_gt1_flag[ n ] ) | |
| abs_remainder[ n ] | |
| AbsLevel[ xC ][ yC ] = AbsLevelPass1[ xC ][ yC ] + | |
| 2 * abs_level_gt2_flag[ n ] + abs_remainder[ n ] ) | |
| } | |
| for( n = firstPosMode1; n > firstPosMode2; n− − ) { | |
| xC = ( xS << log2SbSize ) + DiagScanOrder[ log2SbSize ][ log2SbSize ][ n ][ 0 ] | |
| yC = ( yS << log2SbSize ) + DiagScanOrder[ log2SbSize ][ log2SbSize ][ n ][ 1 ] | |
| if( abs_level_gt1_flag[ n ] ) | |
| abs_remainder[ n ] | |
| AbsLevel[ xC ][ yC ] = AbsLevelPassl[ xC ][ yC ] + 2 * abs_remainder[ n ] | |
| } | |
| //=== fourth pass: bypass bins of absolute levels for scan positions not included in 1^{st} pass === | |
| for( n = firstPosMode2; n >= 0; n− − ) { | |
| xC = ( xS << log2SbSize ) + DiagScanOrder[ log2SbSize ][ log2SbSize ][ n ][ 0 ] | |
| yC = ( yS << log2SbSize ) + DiagScanOrder[ log2SbSize ][ log2SbSize ][ n ][ 1 ] | |
| abs_level[ n ] | |
| AbsLevel[ xC ][ yC ] = abs_level[ n ] | |
| if( abs_level[ n ] > 0 ) | |
| firstSigScanPosSb = n | |
| if( dep_quant_enabled_flag ) | |
| [symbol] [symbol] | |
| } | |
| if( dep_quant_enabled_flag \| \| !sign_data_hiding_enabled_flag ) | |
| signHidden = 0 | |
| else | |
| signHidden = ( lastSigScanPosSb − firstSigScanPosSb > 3 ? 1 : 0 ) | |
| for( n = numSbCoeff − 1; n >= 0; n− − ) { | |
| xC = ( xS << log2SbSize ) + DiagScanOrder[ log2SbSize ][ log2SbSize ][ n ][ 0 ] | |
| yC = ( yS << log2SbSize ) + DiagScanOrder[ log2SbSize ][ log2SbSize ][ n ][ 1 ] | |
| if( sig_coeff flag[ xC ][ yC ] && | |
| ( !signHidden \| \| ( n != firstSigScanPosSb ) ) ) | |
| coeff_sign_flag [ n ] | ae(v) |
| } | |
| if( dep_quant_enabled_flag ) { | |
| state = startQStateSb | |
| for( n = numSbCoeff − 1; n >= 0; n− − ) { | |
| xC = ( xS << log2SbSize ) + | |
| DiagScanOrder[ log2SbSize ][ log2SbSize ][ n ][ 0 ] | |
| yC = ( yS << log2SbSize ) + | |
| DiagScanOrder[ log2SbSize ][ log2SbSize ][ n ][ 1 ] | |
| if( sig_coeff flag[ xC ][ yC ] ) | |
| TransCoeffLevel[ x0 ][ y0 ][ cIdx ][ xC ][ yC ] = | |
| ( 2 * AbsLevel[ xC ][ yC ] − ( state > 1 ? 1 : 0 ) ) * | |
| ( 1 − 2 * coeff_sign_flag[ n ] ) | |
| [symbol] [symbol] | |
| } else { | |
| sumAbsLevel = 0 | |
| for( n = numSbCoeff − 1; n >= 0; n− − ) { | |
| xC = ( xS << log2SbSize ) + | |
| DiagScanOrder[ log2SbSize ][ log2SbSize ][ n ][ 0 ] | |
| yC = ( yS << log2SbSize ) + | |
| DiagScanOrder[ log2SbSize ][ log2SbSize ][ n ][ 1 ] | |
| if( sig_coeff flag[ xC ][ yC ]) { | |
| TransCoeffLevel[ x0 ][ y0 ][ cIdx ][ xC ][ yC ] = | |
| AbsLevel[ xC ][ yC ] * ( 1 − 2 * coeff sign_flag[ n ] ) | |
| if( signHidden ) { | |
| sumAbsLevel += AbsLevel[ xC ][ yC ] | |
| if( ( n = = firstSigScanPosSb ) && ( sumAbsLevel % 2) = = 1 ) ) | |
| TransCoeffLevel[ x0 ][ y0 ][ cIdx ][ xC ][ yC ] = | |
| −TransCoeffLevel[ x0 ][ y0 ][ cIdx ][ xC ][ yC ] | |
| } | |
| } | |
| } | |
| } | |
| } | |
| if( cu_mts_flag[ x0 ][ y0 ] && ( cIdx = = 0) && | |
| !transform_skip_flag[ x0 ][ y0 ][ cIdx ] && | |
| ( ( CuPredMode[ x0 ][ y0 ] = = MODE_INTRA && numSigCoeff > 2 ) \| \| | |
| ( CuPredMode[ x0 ][ y0 ] = = MODE_INTER ) ) ) { | |
| mts_idx[ x0 ][ y0 ] | ae(v) |
| } | |

1. A method for video encoding, comprising:
selecting a first quantization mode comprising a dependent scalar quantization mode for processing a first portion of a set of transform coefficients based on a block being an intra-coded block;
selecting a second quantization mode different from the first quantization mode for processing a second portion of the set of transform coefficients based on the block being an inter-coded block; and
encoding video based on the processed first and second portions of the set of transform coefficients.

2. A method for video decoding, comprising:
selecting a first quantization mode comprising a dependent scalar quantization mode for processing a first portion of a set of transform coefficients based on a block being an intra-coded block;
selecting a second quantization mode different from the first quantization mode for processing a second portion of the set of transform coefficients based on the block being an inter-coded block; and
decoding video based on the processed first and second portions of the set of transform coefficients.

3. An apparatus for video encoding, comprising
one or more processors, wherein the one or more processors are configured to:
select a first quantization mode comprising a dependent scalar quantization mode for processing a first portion of a set of transform coefficients based on a block being an intra-coded block;
select a second quantization mode different from the first quantization mode for processing a second portion of the set of transform coefficients based on the block being an inter-coded block; and
encode video based on the processed first and second portions of the set of transform coefficients.

4. An apparatus for video decoding, comprising
one or more processors, wherein the one or more processors are configured to:
select a first quantization mode comprising a dependent scalar quantization mode for processing a first portion of a set of transform coefficients based on a block being an intra-coded block;
select a second quantization mode different from the first quantization mode for processing a second portion of the set of transform coefficients based on the block being an inter-coded block; and
decode video based on the processed first and second portions of the set of transform coefficients.

5-11. (canceled)

12. The apparatus of claim 4, wherein the dependent scalar quantization depends on a value of a previous transform coefficient in reconstruction order.

13. (canceled)

14. The apparatus of claim 4, wherein the dependent scalar quantization is applied to transform coefficients in the first portion which has lower frequency than the second portion.

15. The apparatus of claim 14, wherein the quantization during the second quantization mode is applied to transform coefficients in the second portion which has higher frequency than the first portion.

16. The apparatus of claim 4, wherein selecting the first quantization mode is further based on a component characteristic of the block.

17-18. (canceled)

19. The apparatus of claim 16, wherein the component characteristic of the block comprises whether the block is a luma component or a chroma component of the video, and selecting the first quantization mode is further based on the block being the luma component and selecting the second quantization mode is further based on the block being the chroma component.

20. (canceled)

21. A non-transitory computer readable medium containing data content generated according to the method of claim 2.

22. A non-transitory computer readable medium storing instructions for performing the method of claim 1 when executed by one of more processors.

23. (canceled)

24. The apparatus of claim 4, further comprising:
at least one of (i) an antenna configured to receive a signal, the signal including data representative of the image information, (ii) a band limiter configured to limit the received signal to a band of frequencies that includes the data representative of the image information, and (iii) a display configured to display an image from the image information.

25. The apparatus of claim 24, wherein the apparatus is included in one of a television, a television signal receiver, a set-top box, a gateway device, a mobile device, a cell phone, a tablet, or other electronic device.

26. The method of claim 2, wherein the dependent scalar quantization depends on a value of a previous transform coefficient in reconstruction order.

27. The method of claim 2, wherein the dependent scalar quantization is applied to transform coefficients in the first portion which has lower frequency than the second portion.

28. The method of claim 27, wherein the quantization during the second quantization mode is applied to transform coefficients in the second portion which has higher frequency than the first portion.

29. The method of claim 2, wherein selecting the first quantization mode is further based on a component characteristic of the block.

30. The method of claim 29, wherein the component characteristic of the block comprises whether the block is a luma component or a chroma component of the video, and selecting the first quantization mode is further based on the block being the luma component and selecting the second quantization mode is further based on the block being the chroma component.
